(19) United States
(12) Patent Application Publication
(10) Pub. No.: US 2014/0278191 A1
(43) Pub. Date: Sep. 18, 2014

(54) Systems and Methods for Calibrating an Accelerometer

(71) Applicant: KIONIX, INC., Ithaca, NY (US)

(72) Inventor: Erik ANDERSON, Sunnyvale, CA (US)

(73) Assignee: Kionix, Inc., Ithaca, NY (US)

(21) Appl. No.: 13/834,310

(22) Filed: Mar. 15, 2013

(51) Int. Cl. G01P 21/00

(52) U.S. Cl. CPC G01P 21/00
USPC 702/104

(57) ABSTRACT

A method for calibrating an accelerometer of an electronic device to reduce an error of the accelerometer includes estimating a gravity vector using the accelerometer and a magnetic field vector using a magnetometer at a plurality of times. The method also includes calculating a characteristic that is a function of an angle between the estimated gravity vector and the estimated magnetic field at each of the plurality of times. Additionally, the method includes calculating a figure of merit over the plurality of times that is a function of the characteristic. The method includes dynamically adjusting a calibration parameter of the accelerometer during ordinary use of the electronic device such that the figure of merit is minimized. Adjusting the calibration parameter reduces the error of the accelerometer. A system can include a accelerometer, a magnetometer, a processor, and a memory having instructions to execute the calibration method on the processor.

### BACKGROUND

1. Field

Embodiments are directed generally to electronic systems and accelerometers, and specifically, to methods of calibrating accelerometers used in various electronic devices and systems.

2. Background Art

An accelerometer is a device that measures the static and dynamic forces of acceleration on an object. The static force is generated by the Earth's gravitational pull, and dynamic forces are caused by movement or vibrations of the object. Accelerometers typically include sources of error. One source of error can be a sensor bias error. The sensor bias error (zero G offset) is the difference between the ideal zero G output and the zero G output (estimated gravity vector) reported by the sensor. Another source of error is the sensitivity. Sensitivity error includes, for example, temperature dependent and ratiometric errors.

Accelerometers can be calibrated to reduce or eliminate such errors by adjusting the calibration parameters. For example, the offset trim code and gain of a calibration algorithm can be adjusted. Typically, accelerometer calibration is performed during manufacturing. Accordingly, calibration increases the manufacturing time and, thus, manufacturing costs. Additionally, calibration during manufacturing cannot take into account changes that occur after manufacturing, for example, temperature changes or changes in mechanical stresses on the accelerometer package.

### BRIEF SUMMARY

In an embodiment, a method for calibrating an, accelerometer of an electronic device to reduce an en or of the accelerometer includes estimating a gravity vector using the accelerometer and a magnetic field vector using a magnetometer at a plurality of times. The method also includes calculating a characteristic that is a function of an angle between the estimated gravity vector and the estimated magnetic field at each of the plurality of times. Additionally, the method includes calculating a figure of merit over the plurality of times that is a function of the characteristic. The method includes dynamically adjusting a calibration parameter of the accelerometer during ordinary use of the electronic device such that the figure of merit converges. Adjusting the calibration parameter reduces the error of the accelerometer.

In another embodiment, a method for calibrating an accelerometer to reduce an error of the accelerometer includes receiving accelerometer datasets from the accelerometer at a plurality of times and receiving magnetometer datasets from the magnetometer at the plurality of times. The method also includes adding the received accelerometer datasets and the received magnetometer datasets at the plurality of times to a data store when a difference between the received magnetometer datasets and a magnetometer dataset last stored in a data store is greater than a defined threshold. Further, the method includes aggregating the received accelerometer datasets and the magnetometer datasets with an accelerometer dataset and the magnetometer dataset last stored in the data store when the difference between the received magnetometer dataset and the magnetometer dataset last stored in the data store is less than a defined threshold. The method also includes estimating a gravity vector for each accelerometer dataset stored in the data store and estimating a magnetic field vector for each magnetometer dataset stored in the data store. Additionally, the method includes calculating a characteristic that is a function of an angle between the estimated gravity vector and the estimated magnetic field, at each of the plurality of times. Additionally, the method includes calculating a figure of merit over the plurality of times that is a function of the characteristic. The method includes dynamically adjusting a calibration parameter of the accelerometer during ordinary use of the electronic device such that the figure of merit converges. Adjusting the calibration parameter reduces the error of the accelerometer.

In another embodiment, a system includes an accelerometer, a magnetometer, a processor, and a memory. The memory stores a calibration parameter of the accelerometer and instructions to be executed by the processor. The instructions include estimating a gravity vector using the accelerometer and a magnetic field vector using a magnetometer at a plurality of times. The instructions also include calculating a characteristic that is a function of an angle between the estimated gravity vector and the estimated magnetic field at each of the plurality of times. Additionally, the instructions include calculating a figure of merit over the plurality of times that is a function of the characteristic. The instructions include dynamically adjusting a calibration parameter of the accelerometer during ordinary use of the electronic device such that the figure of merit converges. Adjusting the calibration parameter reduces the error of the accelerometer.

Further features and advantages of the embodiments, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 is a block diagram of an electronic device according to an embodiment.

FIGS. 2A and 2B are schematic diagrams of an electronic device showing an estimated gravity vector, estimated magnetic field vector, and a sensor bias error, according to an embodiment.

FIGS. 3A and 3B are schematic diagrams of the electronic device of FIGS. 2A-2B after at least one iteration of calibration parameter adjustment using a calibration method according to an embodiment.

FIG. 4 is a block diagram of a method for calibrating an accelerometer according to an embodiment.

FIG. 5 is a block diagram of a method for collecting accelerometer and magnetometer data according to an embodiment.

FIG. 6 is a block diagram of an electronic device according to an embodiment.

FIG. 7 is a block diagram of an exemplary computing environment in which embodiments of an electronic device may be implemented.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Accelerometers used with electronic devices and systems can have a sensor bias error. Accelerometers can be calibrated to reduce this error. A method for calibrating an accelerometer investigates a characteristic of the electronic device that is asymmetric as the electronic device (and the accelerometer) moves with a non-zero component of rotation about the world z-axis, when a sensor bias error exists. In some embodiments, the characteristic of the electronic device is a function of an angle between an estimated gravity vector determined by using the accelerometer and an estimated magnetic field vector. The degree of asymmetry of the characteristic, which is indicative of whether the accelerometer is calibrated, can be quantified by a figure of merit. For exan ple, the figure of merit can be a second moment about a mean value of the characteristic as well as other suitable expressions as described below. A calibration parameter of a calibration algorithm (for example, an offset parameter or a sensitivity parameter) can be adjusted such that the figure of merit is minimized, and at that point, the accelerometer is substantially calibrated. Thus, adjusting the calibration parameter accordingly reduces and/or eliminates the sensor bias error.

FIG. 1 is a block diagram of an electronic device 100 having an accelerometer that can be calibrated according to an embodiment. Electronic device 100 may be a programmable electronic machine that performs high-speed mathematical and logical operations, and that assembles, stores, correlates and otherwise processes data. In some embodiments, electronic device 100 may be a personal computer, a mobile communication device (for example, a smartphone, a tablet computing device, and a laptop notebook), a set-top box, a game-console, an embedded system, or any other suitable electronic device. In some embodiments, electronic device 100 can be configured to measure the static and/or dynamic forces of acceleration acting thereon. The features and hardware included in electronic device according to other embodiments are described with reference to FIGS. 6 and 7.

In some embodiments, electronic device 100 may execute or interpret multiple applications. The applications may be installed or downloaded to electronic device 100, using a network or the external secondary storage units such as those described in FIG. 7. In some embodiments, the applications may be external to electronic device 100, and receive data from electronic device 100 over a network. A network may be any network or combination of networks that can carry data communication. Such a network may include, but is not limited to, a local area network, metropolitan area network, and/or wide area network, such as the Internet. A network can support protocols and technologies including, but not limited to, World Wide Web protocols and/or services. The applications are executed on or receive data from electronic device 100.

In some embodiment, electronic device 100 includes an accelerometer 102 and magnetometer 104. Accelerometer 102 can measure the static and/or dynamic forces of acceleration on an object. For example, accelerometer 102 can be used to determine a vector that is the sum of gravity and linear acceleration experienced by electronic device 100. Magnetometer 104 can measure magnitudes and directions of magnetic fields. For example, absent local interference or anomalies, magnetometer 104 can be used to determine a vector that points towards the Earth's magnetic north. Magnetometer 104 can also be used to observe different types of magnetic anomalies. Examples of magnetic anomalies include magnetic fields generated by hard-iron interferences that may be temporarily or permanently in a vicinity of electronic device 100. Other examples of magnetic anomalies include, but are not limited to, soft iron anomalies where the materials and geometry of device under test and the surrounding environment modify magnetic flux from the earth field, resulting in passive changes to the observed magnetic field.

Although accelerometer 102 and magnetometer 104 are shown within electronic device 100 in FIG. 1, accelerometer 102 and magnetometer 104 may be positioned outside of electronic device 100 in some embodiments. For example, in such embodiments, accelerometer 102 and magnetometer 104 may be positioned outside a housing of electronic device 100 and may be coupled to electronic device 100 using a wired or wireless network.

In some embodiments, accelerometer 102 is a three-axis accelerometer. In some embodiments, accelerometer 102 is a two-axis accelerometer or an accelerometer configured to determine acceleration along more than three axes. In some embodiments, magnetometer 104 is a three-axis magnetometer. In some embodiments, magnetometer 104 is a two-axis magnetometer, or a more than three-axis magnetometer. In some embodiments, accelerometer 102 and magnetometer 104 can be micro-electromechanical system (MEMS) devices. In some embodiments, accelerometer 102 and magnetometer 104 can be non-MEMS devices.

Electronic device 100 can include other features and hardware not shown in FIG. 1. For example, electronic device 100 can include the features and hardware described with reference to FIGS. 6 and 7. And in some embodiments, electronic device 100 can include a gyroscope and/or an altimeter.

FIGS. 2A, 2B, 3A, and 3B are schematic diagrams of an electronic device 200, according to an embodiment, that includes an accelerometer (for example, accelerometer 102 in FIG. 1) and a magnetometer (for example, magnetometer 104 in FIG. 11. For example, the accelerometer and magnetometer of electronic device 200 can be accelerometer 102 and magnetometer 104 described above with reference to FIG. 1. As shown in FIGS. 2A, 2B, 3A, and 3B, electronic device 200, using the accelerometer, can calculate an estimated gravity vector Z_{device}. Electronic device 200, using the magnetometer, can calculate an estimated vector of the Earth's magnetic field MF. Referring to FIGS. 2A and 2B, the accelerometer of electronic device 200 may have a sensor bias error φ₁. That is, the estimated gravity vector Z_{device} is offset from a world z-axis Z_{world}, by an angle of φ₁.

Typically, the accelerometer of an electronic device would be calibrated to reduce or eliminate a sensor bias error φ at the manufacturing stage of the accelerometer, itself, and/or at the manufacturing stage of the electronic device that includes the accelerometer. In some embodiments, instead of calibrating the accelerometer of electronic device 200 during the manufacturing stage (of the accelerometer, itself, or electronic device 100) to reduce or eliminate sensor bias error φ₁, the accelerometer can be calibrated during the ordinary operation of electronic device 200. For example, an accelerometer of a mobile telecommunication device 200 can be calibrated while an end-user (for example, the consumer) ordinarily uses the device after the manufacturing stage. During ordinary operation, the end-user moves electronic device 100 and, thus, changes the orientation of electronic device 200 relative to the real world coordinates. During such ordinary use, electronic device 200 collects accelerometer data trom the accelerometer (for example, accelerometer 102 as shown in FIG. 1), and magnetometer data from the magnetometer (for example, magnetometer 104 as shown in FIG. 1). Electronic device 200 can use this data collected during ordinary operation of electronic device 200 to calibrate the accelerometer of electronic device 200 and, thus, reduce (or eliminate) sensor bias error φ.

FIG. 4 is a block diagram of a method 414 of calibrating an accelerometer of an electronic device to reduce or eliminate a sensor bias error of the accelerometer, according to an embodiment. The sensor bias error can be for example, sensor bias errors φ₁ and φ₂ as shown in FIGS. 2A, 2B, 3A, and 3B. In some embodiments, method 414 is conducted during the ordinary operation of the electronic device. That is, in some embodiments, method 414 is conducted after manufacturing the accelerometer and/or the electronic device using the accelerometer.

In some embodiments, method 414 includes a data collection step 416, a characteristic calculation step 417, a figure of merit calculation step 418, and a calibration parameter adjustment step 420. At step 416, a plurality of accelerometer datasets and a plurality of respective magnetometer datasets are collected from an accelerometer and a magnetometer, respectively, at a plurality of times. In some embodiments, step 416 can begin when the electronic device using the accelerometer and the magnetometer is turned on. In some embodiments, each accelerometer dataset includes an x-axis acceleration component, a y-axis acceleration component, and a z-axis acceleration component (for example, Ax, Ay, and Az). In some embodiments, each magnetometer dataset includes a x-axis magnetic field component, a y-axis magnetic field component, and a z-axis magnetic field component (for example, Mx, My, Mz).

In some embodiments, the collected accelerometer and magnetometer datasets are stored in a data store (for example, data store 636 in FIG. 6). For example, the data store can be located in a memory (for example, memory 108 in FIG. 1 or memory 608 in FIG. 6) of the electronic device (for example, electronic device 100 in FIG. 1 or electronic device 600 in FIG. 6). FIG. 5 is a block diagram of a method for collecting accelerometer and magnetometer data at step 416, according to an embodiment. At step 522, a respective pair of an accelerometer dataset and a magnetometer dataset is collected. Then at step 524, the received magnetometer dataset is compared with a most recent magnetometer dataset stored in the data store to determine whether the orientation of the electronic device has changed a sufficient amount to warrant adding the respective pair of accelerometer and magnetometer datasets to the data store as a new discrete measurement dataset. If the change in the orientation of the electronic device exceeds a defined threshold, the received accelerometer and magnetometer datasets are added to the data store as a discrete new measurement. If the change in the orientation of the electronic device does not exceed the defined threshold, the received accelerometer and magnetometer datasets are aggregated with the most recent measurement stored in the data store. For example, at step 524, the angle between an estimated magnetic field vector determined from the magnetometer dataset received is compared to an estimated magnetic field vector determined from the magnetometer dataset of the most recent measurement dataset stored in the data store. In some embodiments, the defined threshold of the angle can range from about 2 degrees to about 8 degrees. In some embodiments, the defined threshold can be about 5 degrees.

In some embodiments, if the angle between the estimated magnetic field vector determined from the magnetometer dataset received and the estimated magnetic field vector determined from the magnetometer dataset of the most recent measurement dataset stored in the data store is greater than the defined threshold, the received magnetometer and accelerometer datasets are added to the data store as a new discrete measurement dataset, and a field for the number of points in the data store contributing to the new measurement is set to 1 at step 526. In some embodiments, if the angle difference between these two estimated magnetic field vectors does not exceed the defined threshold, the received accelerometer and magnetometer datasets are aggregated with the most recent measurement dataset stored in the data store at step 528. For example, at step 528, the received accelerometer and magnetometer datasets can be linearly combined per component value with the respective components of the measurement dataset last stored in the data store, and a weight of N1/(N1+1) is assigned to the prior measurement value and a weight of 1/(N+1) is assigned to the new measurement value. In some embodiments, the weighting can be set to a maximum to limit the amount of time that measurements contribute to the total solution. For example, the maximum can be set to a value of 31 to limit the amount of time that measurements contribute to the total solution.

In some embodiments, data collection step 416 can include a data compression step. For example, after the received accelerometer and magnetometer datasets are stored in the data store (either as a new measurement dataset (step 526) or aggregated with an existing measurement dataset (step 528)), a check is made as to whether to compress the data store. Such data compression can limit the total size of the stored data used for calibration method 414. In some embodiments, the data store contains between about 50 and about 400 measurement datasets. In some embodiments, the data store contains between about 200 and about 400 measurement datasets. In some embodiments, the data store contains less than about 50 measurement datasets or more than about 400 measurement datasets. In some embodiments, a high water mark of measurement datasets can be defined, for example, about 85 to 95 percent of the maximum number of measurement datasets stored in the data store, and a low water mark of measurement datasets can be defined, for example, 65 to 75 percent of the maximum number of measurement datasets stored in the data store. When the number of datasets exceeds the high water mark, data compression can performed to reduce the number of measurement datasets stored in the data store to a number below the low water mark.

In some embodiments, the data compression step reduces the datasets in the data store by using a method similar to the above-described data point aggregation step 528 for new datasets that do not exceed, for example, an angle threshold difference when compared with the most recent dataset stored in the data store. For example, during the data compression step, instead of investigating the angle between the estimated magnetic field vector determined from the magnetometer dataset received and the estimated magnetic field vector determined from the magnetometer dataset of the most recent measurement dataset stored in the data store, angle differences between the estimated magnetic field vectors determined from each magnetometer dataset stored in the data store are calculated. Over the full data store, the pair of datasets with the least difference in angle for estimated magnetic field vectors is combined, for example, linearly combined, into a single dataset, which frees up one dataset location. In some embodiments, combining the pair of datasets in the data store having the least difference in angle for estimated magnetic field vectors continues until the number of datasets in the data store is reduced to the low water mark.

Calibration method 414 also includes a characteristic calculation step 417. At step 417, a characteristic is calculated for each measurement dataset stored in the data store (for example, data store 636 in FIG. 6). In some embodiments, the characteristic is a function of the angle between an estimated gravity vector (for example, Z_{device} in FIGS. 2A, 2B, 3A, and 3B) and an estimated magnetic field vector (for example, MF in FIGS. 2A, 2B, 3A, and 3B). The estimated gravity vector Z_{device} is calculated from the acceleration data of the measurement dataset stored in the data store, and the estimate magnetic field vector MF is calculated from the respective magnetometer data in the measurement dataset stored in the data store. In some embodiments, the characteristic is the angle between the estimated gravity vector Z_{device}, and the estimated magnetic field vector MF, itself. In some embodiments, the characteristic is the dip angle of the magnetic field (angle between the horizon and the magnetic field vector). The magnetic dip angle is complementary to the angle between the estimated gravity vector Z_{device} and the estimated magnetic field vector MF. In some embodiments, the characteristic is a normalized cross-product of the estimated gravity vector Z_{device} and the estimated magnetic field vector MF (for example, |Z_{device}|X|MF|/(|Z_{device}∥MF|)), or any other characteristic that is a monotonic function of the angle between the estimated gravity vector MF and the estimated magnetic field vector MF.

In some embodiments, the characteristic is asymmetric as the electronic device (for example, electronic device 200 in FIGS. 2A, 2B, 3A, and 3B and electronic device 600 in FIG. 6) moves with a non-zero component of rotation about the world z-axis (parallel to the direction of gravity). Asymmetry in the characteristic as the electronic device rotates about the world z-axis can indicate that the accelerometer is not correctly calibrated and a sensor bias error exists. In some embodiments, when the change of the characteristic is minimized as the electronic device rotates about the world z-axis, the accelerometer is correctly, substantially calibrated. In some embodiments, the accelerometer sensor bias error is the only source of asymmetry, and accordingly, the asymmetry of the characteristic would be completely removed through the calibration process. However, in some embodiments, there are additional sources of asymmetry. For example, a non-zero misalignment angle between the accelerometer and the magnetometer can contribute to the asymmetry of the characteristic. When multiple sources of asymmetry exist, calibrating the accelerometer to reduce or eliminate the sensor bias error will reduce the change of the characteristic as the electronic device moves with a non-zero component of rotation about the world z-axis and, thus, reduce the asymmetry, but the asymmetry may not be completely eliminated.

Calibration method 414 also includes a figure of merit calculation step 418. At step 418, a figure of merit that quantifies the asymmetry of the characteristic is calculated across the range of solid angles represented by the measurement datasets in the data store, in some embodiments. In some embodiments, the figure of merit converges at a value when the characteristic is substantially symmetric as the electronic device rotates about the axis, which indicates the accelerometer is correctly, substantially calibrated.

In some embodiments, the figure of merit is a function of a difference between the characteristic for each measurement dataset stored in the date store and the mean of the characteristic over the measurement datasets stored in the data store. One example of such a figure of merit is a moment about the mean of the characteristic over the measurement datasets. For example, the figure of merit can be a second moment about the mean of the characteristic, that is, a variance of the characteristics. When the variance of the characteristics converges toward a minimum value, the accelerometer is substantially calibrated. In some embodiments in which substantially no noise or sources of asymmetry exist (for example, angle misalignment between the accelerometer and the magnetometer), the variance would converge, to zero. Additional examples of a figure of merit are third, fourth, or more than fourth moments about the mean of the characteristic. Another example of a figure of merit that is a function of a difference between the characteristic for each measurement dataset and the mean of the characteristics includes a standard deviation of the characteristic over the measurement datasets, that is, a square root of the second moment of the mean of the characteristic.

A further example of such a figure of merit that is a function of a difference between the characteristic for each measurement dataset stored in the date store and the mean of each characteristic for each measurement dataset includes a figure of merit that is a function of an expected value of an absolute value of a difference between a characteristic at each of the measurement datasets and a mean of the characteristic over the plurality of measurement datasets. For example, the figure of merit can be characterized as E=[|X−E[X]|^{k}], where X is the characteristic, and k is the order. In some embodiments, k is equal to 1, 2, 3, or more than 3.

In some embodiments, a characteristic that is a function of the angle between an estimated gravity vector and an estimated magnetic field vector will be asymmetric as the electronic device moves with a non-zero component of rotation about the world z-axis when a sensor bias error exists. For example, referring to FIGS. 2A and 2B, an estimate gravity vector Z_{device} and a magnetic field vector MF can be determined from accelerometer data and the respective magnetometer data of a measurement dataset stored in the data store. The angle α₁ between the estimated gravity vector Z_{device} and the estimated magnetic field vector MF can be calculated. As shown in FIG. 2A, a sensor bias error φ1 exists between estimated gravity vector Z_{device} and the world z-axis. The sensor bias error φ₁ projects onto the world x-y plane. As electronic device 200 rotates about the world z-axis, the angle α₁ varies due to sensor bias error φ₁. That is, the angle α is asymmetric when a sensor bias error φ₁ exists. Accordingly, a characteristic that is a function of angle α will also be asymmetric as electronic device 200 rotates when a sensor bias error φ₁ exists. For example, as shown in FIG. 2B, electronic device 200 is rotated 180 degrees about the world z-axis. In FIG. 2B, the angle α_{1B} between the estimated gravity vector Z_{device} and the estimated magnetic field vector MF can be calculated. The angle α_{1B} is smaller than the angle α_{1A} due to sensor bias error φ₁, which is now oppositely signed in world coordinates. This asymmetry of angle α and, consequently, the characteristic (for example, angle α, itself; the magnetic dip angle, the cross product of the estimated gravity vector Z_{device} and the estimated magnetic field vector MF, etc.) indicates that sensor bias error φ₁ indeed exists. When sensor bias error φ₁ exists, the angle α between the estimated gravity vector Z_{device} and the estimated magnetic field vector MF and the characteristic continuously varies as electronic device 200 rotates about, the world z-axis. At this point, the figure of merit does not converge at the value that indicates the accelerometer is substantially calculated. Accordingly, the method 414 proceeds to a calibration parameter adjustment step 420.

At step 420, at least one calibration parameter of a calibration algorithm can be adjusted to reduce or eliminate a sensor bias error of the accelerometer. In some embodiments, any calibration algorithm that can successfully minimize the figure of merit as a function of the calibration parameter(s) can be used. In some embodiments, the adjusted calibration parameter includes an offset parameter, a sensitivity parameter, or both the offset parameter and the sensitivity parameter of the calibration algorithm. In some embodiments, the calibration parameter(s) are adjusted such that the figure of merit (for example, a variance) converges to a minimum value. In this manner, such convergence indicates that the accelerometer of electronic device 200 is substantially calibrated. For example, if the figure of merit is a variance of the angle between the estimated gravity vector and the estimated magnetic field vector, the figure of merit converges to a minimum value when the accelerometer is substantially calibrated, For example, FIGS. 3A and 3B illustrate electronic device 200 after one or more iterations of adjusting the calibration parameter(s). As shown in FIGS. 3A & 3B, a sensor bias error φ₂ of electronic device 200 is smaller than sensor bias error φ₁ of electronic device 200 in FIGS. 2A and 2B. Accordingly, the angle α_{2A} between the estimated gravity vector Z_{device} and the estimated magnetic field vector MF in FIG. 3A is smaller than the angle α_{1A} between the estimated gravity vector Z_{device} and the estimated magnetic field vector MF in FIG. 2A. And the angle α_{2B} between the estimated gravity vector Z_{device} and the estimated magnetic field vector MF in FIG. 3B is larger than the angle α_{1B} between the estimated gravity vector Z_{device} and the estimated magnetic field vector MF in FIG. 2B. Thus, the figure of merit (for example, a variance of the angle α between the estimated gravity vector Z_{device} and the estimated magnetic field vector MF) of electronic device 200 in FIGS. 3A and 3B is smaller—the figure of merit is converging. This decrease in the figure of merit indicates that the accelerometer of electronic device 200 is more closely calibrated, but until the figure of merit converges sensor bias φ₂ still exists. The calibration parameter(s) are continually adjusted until the figure of merit (for example, variance of the characteristic) converges to a value within a predetermined threshold. In some embodiments, this threshold corresponds to a sensor bias error equal to or less than about 5 milligees.

In some embodiments, the calibration parameter(s) are dynamically adjusted during the ordinary operation of the electronic device. That is, the calibration parameters are adjusted after the manufacturing stage of the accelerometer and/or electronic device. In some embodiments, dynamically calibrating the accelerometer allows the effects of changes in the environment on the sensor bias error to be compensated for. For example, dynamically calibrated the accelerometer allows for compensation of temperature shifts, package stress changes, and other environmental changes that affect the sensor bias error after the manufacturing, stage.

In some embodiments, dynamically calibrating the accelerometer during ordinary operation of the electronic device reduces or eliminates the need to obtain a truth reference or manually calibrate the accelerometer. In such embodiments, calibration during the manufacturing stage of the accelerometer and/or electronic device can be omitted. This omission can reduce production time of the accelerometer and/or electronic device and, thus, reduce manufacturing costs. This omission of manufacturing calibration can also reduce or eliminate the need for complex acceleration test fixtures.

In some embodiments, dynamically calibrating the accelerometer during ordinary operation of the electronic device allows the calibration to compensate for changes that affect calibration that occur after manufacturing. Such changes include, for example, temperature shifts and changing mechanical stresses on the package of the accelerometer in the electronic device. Accordingly, in some embodiments, the accelerometer can accurately measure static and/or dynamic accelerations throughout the entire life of the electronic device without manual calibrating the accelerometer. In some embodiments, dynamically calibrating the accelerometer during ordinary operation of the electronic device occurs without any explicit action by accelerometer and/or electronic device manufacturer or the end-user.

In some embodiments, the calibration parameter(s) are adjusted by using a gradient path to converge the figure of merit. In some embodiments using a gradient path, the calibration parameter(s) are varied on each axis successively for each iteration of the calibration parameter(s) update. For each axis update, three calibration parameter(s) are used: prompt, early, and late calibration parameter(s) estimates. The most recent estimate is the prompt estimate. The early estimate is the prompt estimate minus the bias span, and the last estimate is the prompt estimate plus the bias span. In some embodiments, the bias span is about 5 milligees to about 15 milligees. In some embodiments, the bias span is about 10 milligees. If the figure of merit is monotonic for the prompt, early, and late bias estimates, the calibration parameter(s) estimates are shifted by the bias span in the direction of the lower valued figure of merit and recalculated. In some embodiments, the calculated calibration parameter(s) estimates are re-used so that one new value is calculated for the figure of merit for each shift. Once the calibration parameter(s) estimates are calculated such that the figure of merit is no longer monotonic from early to late estimates, peak refinement can occur. Using a peak refinement algorithm in some embodiments, the estimated calibration parameter(s) corresponding to the two lowest values for the figure of merit are refined to five points. The two original points in the refinement are the second and fourth points of the five-point refinement cycle. The first point is the sum of minus one half of the bias span and the second point. The third point is the sum of one half of the bias span and the refined second point. And the fifth point is the sum of one half of the bias span and the refined fourth point. The bias span is then updated for the next cycle. In some embodiments, the bias span is updated by reducing, in half. In some embodiments, this cycle continues as long as clear minima are observed in the refined five point series and until a minimum separation threshold is crossed. In some embodiments, the minimum threshold separation is about 0.5 milligee to about 1.5 milligees. In some embodiments, the minimum threshold separation is about 1 milligee. In some embodiments, a final refinement stage is performed. In some embodiments, the final refinement quadratically interpolates the three lowest points of the last five point refinement cycle.

In some embodiments, the magnetometer used for estimating the magnetic field vector can be calibrated before calibrating the accelerometer according to the above described embodiments. In some embodiments in which the magnetometer is calibrated first, the figure of merit converges more quickly and accurately relative to calibrating the accelerometer without first calibrating the magnetometer. Calibrating the magnetometer first can maximize the observable figure of merit, reducing the effect of sensor noise. The calculated angle between the estimated gravity vector and the estimated magnetic field vector will be reduced by approximately the magnitude of the estimated magnetic field vector based on an incorrectly calibrated magnetometer divided by the magnitude of a correctly calibrated magnetic field.

In some embodiments, the figure of merit is a smoothly varying function of accelerometer bias error with a global minimum for fixed accelerometer sensitivity. If, however, the search for sensor bias error and sensitivity is unconstrained, there is no longer a single minimal solution, though the alternate solutions tend to correspond to severely distorted sensitivities. In some embodiments, sensor bias error is searched for initially, and once it has converged, a search for sensitivity is initiated while sensor bias error continues to be tracked. Updates to sensor bias error can be permitted more rapidly than sensitivity. To avoid sensitivity divergence, which can occur from excessive sensor noise, a maximum range can be set for permitted sensitivity. If sensitivity estimate exceeds set range, the sensitivities are reset to nominal values of 1.0 and convergence begins again.

FIG. 6 is a block diagram of an electronic device 600 according to an embodiment. Electronic device 600 can include an accelerometer 602, a magnetometer 604, a processor 606, and a memory 608. Memory 608 may include instructions 630 configured to be executed or interpreted by processor 606. Instructions 630 can include code that cause processor 606 to perform one or more steps of calibration method 414 as discussed above. Memory 608 can also include a data store 632 that includes measurement datasets (including, in some embodiments, received accelerometer and magnetometer data) used in calibration method 414. Memory 608 can also include a registry 634 of calibration parameters used to minimize or reduce a sensor bias error and improve sensitivity of accelerometer 602.

Various embodiments can be implemented, for example, using one or more well-known computer systems, such as computer system 736 shown in FIG. 7. Computer system 736 can be any well-known computer capable of performing the functions described herein, such as computers available from International Business Machines, Apple, Sun, HP, Dell, Sony, and Toshiba, to name a few examples.

Computer system 736 includes one or more processors (also called central processing units, or CPUs), such as a processor 738. Processor 738 is connected to a communication infrastructure or bus 740. In an embodiment, processor 738 may be a graphics processing unit (GPU). A GPU is a processor that is a specialized electronic circuit designed to rapidly process mathematically intensive applications on electronic devices. The GPU has a highly parallel structure that is efficient for parallel processing of large blocks of data, such as mathematically intensive data common to computer graphics applications, images and videos.

Computer system 736 also includes user input/output device(s) 742, such as monitors, keyboards, pointing devices, etc., which communicate with communication infrastructure 740 through user input/output interface(s) 744.

Computer system 726 also includes a main or primary memory 746, such as random access memory (RAM). Main memory 746 may include one or more levels of cache. Main memory 746 has stored therein control logic (i.e., computer software) and/or data.

Computer system 736 may also include one or more secondary storage devices or secondary memory 748. Secondary memory 748 may include, for example, a hard disk drive 750 and/or a removable storage, device or drive 752. Removable storage drive 752 may be a floppy disk drive, a magnetic tape drive, a compact disk drive, an optical storage device, tape backup device, and/or any other storage device/drive.

Removable storage drive 752 may interact with a removable storage unit 754. Removable storage unit 754 includes a computer usable or readable storage device Laving stored thereon computer software (control logic) and/or data. Removable storage unit 754 may be a floppy disk, magnetic tape, compact disk, DVD, optical storage disk, or any other computer data storage device. Removable storage drive 752 reads from and/or writes to removable storage unit 754 in a well-known manner.

According to an exemplary embodiment, secondary memory 748 may include other means, instrumentalities or approaches for allowing computer programs and/or other instructions and/or data to be accessed by computer system 736. Such means, instrumentalities or approaches may include, for example, a removable storage unit 756 and an interface 758. Examples of the removable storage unit 756 and the interface 758 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 736 may further include a communication or network interface 760. Communication interface 760 enables computer system 736 to communicate and interact with any combination of remote devices, remote networks, remote, entities, etc. (individually and collectively referenced by reference number 762). For example, communication interface 760 may allow computer system 736 to communicate with remote devices 762 over communications path 764, which may be wired, and/or wireless, and which may include any combination of LANs, WANs, the Internet, etc. Control logic and/or data may be transmitted to and from computer system 736 via communication path 764.

In an embodiment, a tangible apparatus or article of manufacture comprising a tangible computer useable or readable medium having control logic (software) stored thereon is also referred to herein as a computer program product or program storage device. This includes, but is not limited to, computer system 736, main memory 746, secondary memory 748, and removable storage units 754 and 756, as well as tangible articles of manufacture embodying any combination of the foregoing. Such control logic, when executed by one or more data processing devices (such as computer system 736), causes such data processing devices to operate as described herein.

Based on the teachings contained in this disclosure, it will be apparent to persons skilled in the relevant art(s) how to make and use the embodiments using data processing devices, computer systems and/or computer architectures other than that shown in FIG. 7. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments as contemplated by the inventor(s), and thus, are not intended to limit the embodiments or the appended claims in any way.

While the embodiments have been described herein with reference to exemplary embodiments for exemplary fields and applications, it should be understood that the subject matter is not limited thereto. Other embodiments and modifications thereto are possible, and are within the scope and spirit of the subject matter. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” “some embodiments,” “examples,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the embodiments should not be limited by any of the above-described exemplary embodiments, but should be defined only in accordance with the following claims and their equivalents.

What is claimed is:

1. A method for calibrating an accelerometer of an electronic device to reduce an error of the accelerometer, comprising:
estimating a gravity vector using the accelerometer at a plurality of times;
estimating a magnetic field vector using a magnetometer at the plurality of times;
calculating a characteristic that is a function of an angle between the estimated gravity vector and the estimated magnetic field at each of the plurality of times;
calculating a figure of merit over the plurality of times that is a function of the characteristic; and
dynamically adjusting a calibration parameter of the accelerometer during ordinary use of the electronic device such that the figure of merit converges to a value,
wherein adjusting the calibration parameter reduces the error of the accelerometer.

2. The method of claim 1, wherein the characteristic is a magnetic dip angle.

3. The method of claim 1, wherein the characteristic is a normalized cross-product of the estimated gravity vector and the estimated magnetic field vector.

4. The method of claim 1, wherein the characteristic is the angle between the estimated gravity vector and the estimated magnetic field.

5. The method of claim 1, wherein the figure of merit is a moment about a mean of the characteristic over the plurality of times.

6. The method of claim 5, wherein the moment is a second moment about the mean of the characteristic over the plurality of times.

7. The method of claim 5, wherein the moment is a third or higher moment about a mean of the characteristic over the plurality of times.

8. The method of claim 1, wherein the figure of merit is a square root of a second moment about a mean of the characteristic over the plurality of times.

9. The method of claim 1, wherein the figure of merit is a function of an expected value of an absolute value of a difference between a characteristic at each of the plurality of times and a mean of the characteristic over the plurality of times.

10. The method of claim 1, wherein adjusting the calibration parameter comprises using a gradient path.

11. The method of claim 1, further comprising calibrating the magnetometer before dynamically adjusting the calibration parameter.

12. The method of claim 1, wherein the calibration parameter comprises an offset parameter.

13. The method of claim 1, wherein the calibration parameter further comprises a sensitivity parameter.

14. A method for calibrating an accelerometer to reduce an error of the accelerometer, comprising:
receiving accelerometer datasets from the accelerometer at a plurality of times;
receiving magnetometer datasets from the magnetometer at the plurality of times;
adding the received accelerometer datasets and the received magnetometer datasets at the plurality of times to a data store when a difference between the received magnetometer datasets and a magnetometer dataset last stored in, a data store is greater than a defined threshold;
aggregating the received accelerometer datasets and the magnetometer datasets with an accelerometer dataset and the magnetometer dataset last stored in the data store when the difference between the received magnetometer dataset and the magnetometer dataset last stored in the data store is less than a defined threshold;
estimating a gravity vector for each accelerometer dataset stored in the data store;
estimating a magnetic field vector for each magnetometer dataset stored in the data store;
calculating a characteristic that is a function of an angle between the respective estimated gravity vector and the respective estimated magnetic field vector;
calculating a figure of merit over the plurality of times that is a function of the characteristic; and
dynamically adjusting a calibration parameter of the accelerometer such that the figure of merit converges to a value,
wherein adjusting the calibration parameter reduces the error of the accelerometer.

15. The method of claim 14, wherein the threshold is approximately a 5 degree angle between a magnetic field vector derived from the respective received magnetometer dataset and the magnetic field vector derived from the magnetometer dataset last stored in the data store.

16. The method of claim 14, wherein the characteristic is a magnetic dip angle.

17. The method of claim 14, wherein the characteristic is a normalized cross-product of the estimated gravity vector and the estimated magnetic field vector.

18. The method of claim 14, wherein the characteristic is the angle between the estimated gravity vector and the estimated magnetic field.

19. The method of claim 14, wherein the figure of merit is a moment about a mean of the characteristic over the plurality of times.

20. The method of claim 19, wherein the moment is a second moment about the mean of the characteristic over the plurality of times.

21. The method, of claim 19, wherein the moment is a third or higher moment about a mean of the characteristic over the plurality of times.

22. The method of claim 14, wherein the figure of merit is a square root of a second moment about a mean of the characteristic over the plurality of times.

23. The method of claim 14, wherein adjusting the calibration parameter comprises using a gradient path.

24. The method of claim 14, wherein the calibration parameter comprises an offset parameter.

25. The method of claim 24, wherein the calibration parameter further comprises a sensitivity parameter.

26. A system comprising:
an accelerometer;
a magnetometer;
a processor; and
a memory storing a calibration parameter of the accelerometer and instructions to be executed by the processor, the instructions comprising:
estimating a gravity vector using the accelerometer at a plurality of times;
estimating a magnetic field vector using a magnetometer at the plurality of times;
calculating a characteristic that is a function of an angle between the estimated gravity vector and the estimated magnetic field at each of the plurality of times;
calculating a figure of merit over the plurality of times that is a function of the characteristic; and
dynamically adjusting a calibration parameter of the accelerometer during ordinary use of the electronic device such that the figure of merit converges to a value,
wherein adjusting the calibration parameter reduces an error of the accelerometer.

27. The system of claim 26, wherein the characteristic is a magnetic dip angle.

28. The system of claim 26, wherein the characteristic is a normalized cross-product of the estimated gravity vector and the estimated magnetic field vector.

29. The system of claim 26, wherein the characteristic is the angle between the estimated gravity vector and the estimated magnetic field.

30. The system of claim 26, wherein the figure of merit is a moment about a mean of the characteristic over the plurality of times.

31. The system of claim 26, wherein the moment is a second moment about the mean of the characteristic over the plurality of times.

32. The system of claim 26, wherein the moment is a third or higher moment about a mean of the characteristic over the plurality of times.

33. The system of claim 26, wherein the figure of merit is a square root of a second moment about a mean of the characteristic over the plurality of times.

34. The system of claim 26, wherein the figure of merit is a function of an expected value of an absolute value of a difference between a characteristic at each of the plurality of times and a mean of the characteristic over the plurality of times.

35. The system of claim 26, wherein adjusting the calibration parameter comprises using a gradient path.

36. The system of claim 26, wherein the instructions further comprise calibrating the magnetometer before dynamically adjusting the calibration parameter.

37. The system of claim 26, wherein the calibration parameter comprises an offset parameter.

38. The system of claim 37, wherein the calibration parameter further comprises a sensitivity parameter.

39. The system of claim 26, wherein the accelerometer and the magnetometer are contained within a housing of an electronic device.
